(19) United States
(12) Patent Application Publication
(10) Pub. No.: US 2022/0253635 A1
(43) Pub. Date: Aug. 11, 2022

(54) ATTENTION-DRIVEN SYSTEM FOR ADAPTIVELY STREAMING VEHICLE SENSOR DATA TO EDGE COMPUTING AND CLOUD-BASED NETWORK DEVICES

(71) Applicant: GM GLOBAL TECHNOLOGY OPERATIONS LLC, Detroit, MI (US)

(72) Inventors: Bo YU, Troy, MI (US); Sycamore Zhang, Shanghai (CN); Shuqing Zeng, Sterling Heights, MI (US); Kamran Ali, Troy, MI (US); Vivek Vijaya Kumar, Shelby Township, MI (US); Donald K. Grimm, Utica, MI (US)

(21) Appl. No.: 17/190,663

(22) Filed: Mar. 3, 2021

(30) Foreign Application Priority Data
Feb. 10, 2021 (CN) 202110182693.0

(51) Int. Cl. G06K 9/00; G06K 9/62; G06K 9/32; B60W 60/00; B60W 30/08; G06K 9/68

(52) U.S. Cl. CPC G06K 9/00805; G06K 9/6288; G06K 9/6857; B60W 60/001; B60W 30/08; G06K 9/3233

(57) ABSTRACT

An attention-driven streaming system includes an adaptive-streaming module and a transceiver. The adaptive-streaming module includes filters, a compression module, an attention-driven strategy module and a fusion module. The filters filter sensor data received from sensors of a vehicle. The compression module compresses the filtered sensor data to generate compressed data. The attention-driven strategy module generates feedforward information based on a state of the vehicle and a state of an environment of the vehicle to adjust a region of interest. The fusion module generates an adaptive streaming strategy to adaptively adjust operations of each of the filters. The transceiver streams the compressed data to at least one of an edge computing device or a cloud-based network device and in response receive feedback information and pipeline monitoring information. The fusion module generates the adaptive streaming strategy based on the feedforward information, the feedback information and the pipeline monitoring information.

### CROSS-REFERENCE TO RELATED APPLICATIONS

This application claims the benefit of Chinese Patent Application No. 202110182693.0, filed on Feb. 20, 2021. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to edge computing and cloud-based processing of vehicle sensor data.

An ego-vehicle may include various sensors, such as cameras, radar sensors, lidar sensors, speed sensors, yaw rate sensors, etc. for detecting objects and environmental conditions. An ego-vehicle refers to the vehicle on which sensors are located and processing of at least some of the sensor data occurs. Considerable processing power is needed to receive, process and analyze the sensor data. To reduce processing power and processing time needed at the vehicle, sensor data that is real-time mission critical can be offloaded to an edge computing device or a cloud-based network device. This is done to take advantage of abundant resources (computing and storage resources) at the edge computing device and/or at the cloud-based network device. Results of the processed and analyzed data may then be sent back to the vehicle. Real-time mission critical sensor data may refer to data associated with, for example, a detected oncoming object (or vehicle) and need to be processed quickly in order to avoid a collision.

A cloud-based network can provide computing and storage services from a centralized location. Edge computing using, for example, a fifth generation (5G) broadband cellular network allows sensor data processing to be pushed to an edge of a network of the ego-vehicle. The sensor data can be processed at micro-data centers deployed at cellular towers and/or at regional stations, which can be closer to the ego-vehicle than a cloud-base network device.

Certain vehicle functions may also be offloaded from a vehicle to a cloud-based network device and/or an edge computing device (referred to as a remote processing device). This can include streaming the sensor data to the remote processing device and processing the sensor data according to the vehicle functions. The vehicle functions may include object detection, object tracking, and position and mapping of the ego-vehicle and surrounding objects. The remote processing device may perform these functions based on the received sensor data and results of the analysis may be provided back to the ego-vehicle. Vehicle on-board functions may then be performed based on the results to enhance on-board operations and improve vehicle performance and occupant experience. As a few examples, the on-board functions may include collision avoidance, autonomous driving, driver-assistance, navigation, situation reporting, etc.

### SUMMARY

An attention-driven streaming system is provided and includes an adaptive-streaming module and a transceiver. The adaptive-streaming module includes filters, a compression module, an attention-driven strategy module and a fusion module. The filters are configured to filter sensor data received from sensors of a vehicle. The compression module is configured to compress the filtered sensor data to generate compressed data. The attention-driven strategy module is configured to generate feedforward information based on a state of the vehicle and a state of an environment of the vehicle to adjust a region of interest. The fusion module is configured to generate an adaptive streaming strategy to adaptively adjust operations of each of the filters. The transceiver is configured to stream the compressed data to at least one of an edge computing device or a cloud-based network device and in response receive feedback information and pipeline monitoring information. The fusion module is configured to generate the adaptive streaming strategy based on the feedforward information, the feedback information and the pipeline monitoring information.

In other features, the filters include: a temporal domain filter configured to resample the sensor data at a set frequency; a spatial domain filter configured to select one or more geographical regions external to the vehicle; and a lossy compression filter configured to at least one of select a lossy compression method or a lossy compression rate of the compression module.

In other features, the spatial domain filter is configured to: select one or more image resolutions respectively for the selected one or more geographical regions; apply one or more temporal domain methods respectively to the selected one or more geographical regions; and adjust one or more different lossy compression rates for the one or more regions.

In other features, the feedforward information is a first streaming strategy for streaming data to the at least one of the edge computing device or the cloud-based network device; and the feedback information is a second streaming strategy for streaming data to the at least one of the edge computing device or the cloud-based network device.

In other features, the feedforward information is generated within the vehicle and includes a request for higher resolution data for the region of interest.

In other features, the feedforward information includes a streaming strategy generated based on prediction information generated within the vehicle and indicates a geographical region to focus monitoring. In other features, the filters are configured to adjust a sampling rate of one or more of the sensors for the geographical region based on the streaming strategy in the feedforward information.

In other features, the feedback information is generated within the at least one of the edge computing device or the cloud-based network device and includes a request for higher resolution data for an indicated geographical region.

In other features, the feedback information includes a streaming strategy generated based on prediction information generated within the at least one of the edge computing device or the cloud-based network device and indicates a geographical region to focus monitoring. The filters are configured to adjust a sampling rate of one or more of the sensors for the geographical region based on the streaming strategy included in the feedback information.

In other features, the pipeline monitoring information indicates an adjustment in a streaming rate of the compressed data based on congestion at the at least one of the edge computing device or the cloud-based network device.

In other features, the attention-driven strategy module is configured to generate the feedforward information based on: a probabilistic representation of a state of an object; a confidence level of the state of the object; and a list of objects expected to be observed in the future and events expected to occur in the future.

In other features, the attention-driven strategy module is configured to generate the feedforward information based on at least one of: differences between different sensors; current and upcoming environmental conditions currently experienced or to be experienced by the vehicle; status information from a neighboring vehicle; or map tracking and trajectory planning information.

In other features, the attention-driven strategy module is configured to generate the feedforward information to include one or more attention regions for tasks being performed.

In other features, a vehicle system is provided and includes: the attention-driven streaming system; and the sensors.

In other features, an attention-driven strategy method is provided and includes: filtering via filters sensor data received from sensors at a vehicle; compressing the filtered sensor data to generate compressed data; generating feedforward information based on a state of the vehicle and a state of an environment of the vehicle; generating an adaptive streaming strategy to adaptively adjust operations of each of the filters; and streaming the compressed data from the vehicle to at least one of an edge computing device or a cloud-based network device and in response receiving feedback information and pipeline monitoring information from the edge computing device or the cloud-based network device. The adaptive streaming strategy is generated based on the feedforward information, the feedback information and the pipeline monitoring information.

In other features, the filtering of the sensor data includes: resampling the sensor data at a set frequency; selecting one or more geographical regions external to the vehicle; and at least one of selecting a lossy compression method or a lossy compression rate for compressing the sensor data.

In other features, the feedforward information is a first streaming strategy for streaming data to the at least one of the edge computing device or the cloud-based network device; and the feedback information is a second streaming strategy for streaming data to the at least one of the edge computing device or the cloud-based network device.

In other features, at least one of the feedforward information or the feedback information includes a request for higher resolution data for an indicated geographical region.

In other features, the feedforward information includes a streaming strategy generated based on prediction information generated within the vehicle and indicates a geographical region to focus monitoring. The filtering includes adjusting a sampling rate of one or more of the sensors for the geographical region based on the streaming strategy in the feedforward information.

In other features, the feedback information includes a streaming strategy generated based on prediction information generated within the vehicle and indicates a geographical region to focus monitoring. The filtering includes adjusting a sampling rate of one or more of the sensors for the geographical region based on the streaming strategy in the feedback information.

In other features, the adaptive streaming strategy includes increasing resolution for a first region of interest and decreasing resolution for a second region of interest.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram and view of an example of an attention-driven streaming system including vehicles with adaptive streaming modules in accordance with the present disclosure;

FIG. 2 is a functional block diagram of an example of a vehicle including a vehicle system including an adaptive streaming module in accordance with the present disclosure;

FIG. 3 is a functional block diagram of a portion of the attention-driven streaming system of FIG. 1;

FIG. 4 is a functional block diagram of a portion of the attention-driven streaming system of FIG. 3 including an example of an attention-driven strategies module in accordance with the present disclosure;

FIG. 5 illustrates a first portion of adaptive streaming method implemented by a vehicle in accordance with the present disclosure; and

FIG. 6 illustrates a second portion of the adaptive streaming method implemented by an edge computing device or a cloud-based network device in accordance with the present disclosure.

In the drawings, reference numbers may be reused to identify similar and/or identical elements.

### DETAILED DESCRIPTION

A significant amount of sensor data can be streamed from a vehicle to an edge computing device or a cloud-based network device. This can require a significant amount of bandwidth, time and costs. Certain factors may be adjusted in transmitting the sensor data. The factors include: frequency of the transmitted data (referred to as the temporal domain); region of interest and resolution; and lossy compression rate (or video compression rate) of sensor data. There are trade-offs to consider in adjusting these factors. For example, a trade-off exists between (i) bandwidth usage, and (ii) edge computing/cloud side performance and autonomous vehicle performance. Generally the higher the resolution of sensor data collected and the more sensor data offloaded for processing, the more bandwidth required, the higher the transmission latencies, the higher the processing latencies, and the better the results of the processing. The better the processing results, the better the performance of autonomous vehicle related functions, such as object/collision avoidance and navigation functions.

The examples set forth herein include an attention-driven streaming system including adaptive streaming modules that support adaptive sensor data streaming to edge computing and cloud-based network devices. The adaptive data streaming is based on perception attention. Perception attention refers to the focusing on certain areas (or geographical regions) of concern of an environment. Vehicle functions may be offboarded to edge computing and cloud-based network devices to satisfy an increasing demand of autonomous vehicle computing resources without increasing vehicle onboard hardware costs. Edge computing and cloud-based resources can be shared by multiple vehicles. This decreases per vehicle per hour operating costs associated with using the edge computing and cloud-based resources. The examples include performing operations to solve the trade-off issue between (i) perception performance, which generally improves with increased resolution of data, and (ii) bandwidth requirements that increase with increased resolution. The examples include focusing region monitoring to one or more reduced sized regions of interest. A reduction in a monitored overall region size and/or number of regions, allows for increased resolution for the monitored region(s) while not collecting an additional amount of data, which can require addition bandwidth for offboard streaming. The total amount of data collected may be reduced providing bandwidth savings while at the same time maintaining or improving vehicle perception performance.

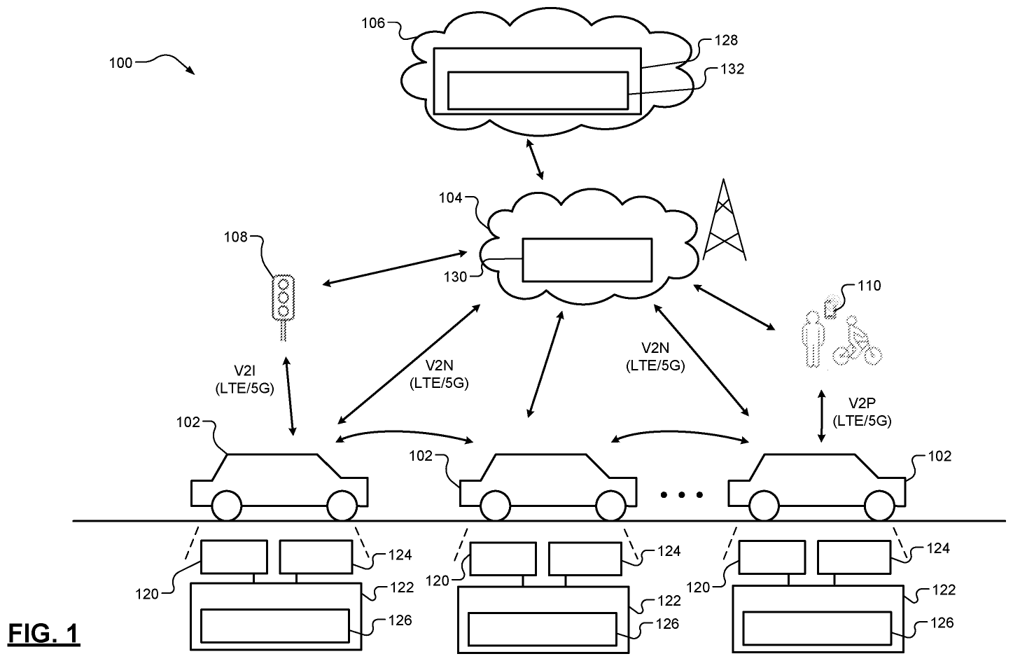

FIG. 1 shows an attention-driven streaming system 100 including vehicles 102, edge computing devices 104, a cloud-based network 106, infrastructure devices 108 and personal mobile network devices 110. The vehicles 102 may each include transceivers 120, control modules 122 and sensors 124. The control modules 122 include adaptive streaming modules 126 that adaptively adjust sampling rates, streaming frequencies, regions of interest (focus regions), resolutions, lossy compression rates, lossy compression methods, and/or other streaming parameters and/or aspects of sensor data sent from the vehicles 102 to the edge computing devices 104 and/or cloud-based network devices 128 of the cloud-based network 106.

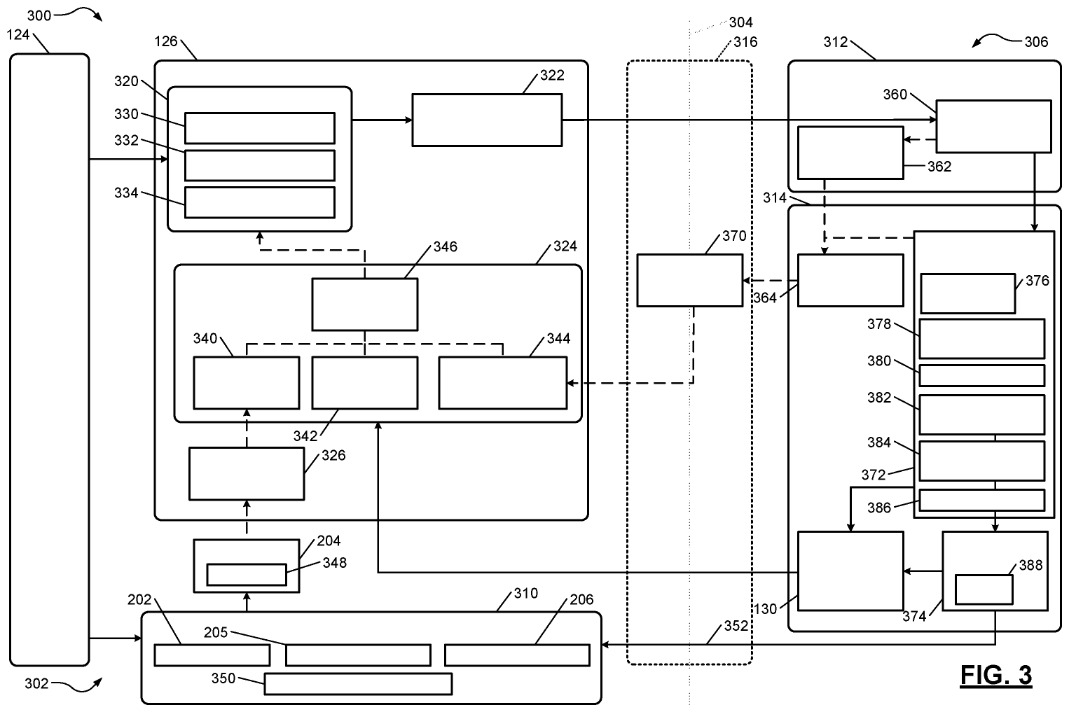

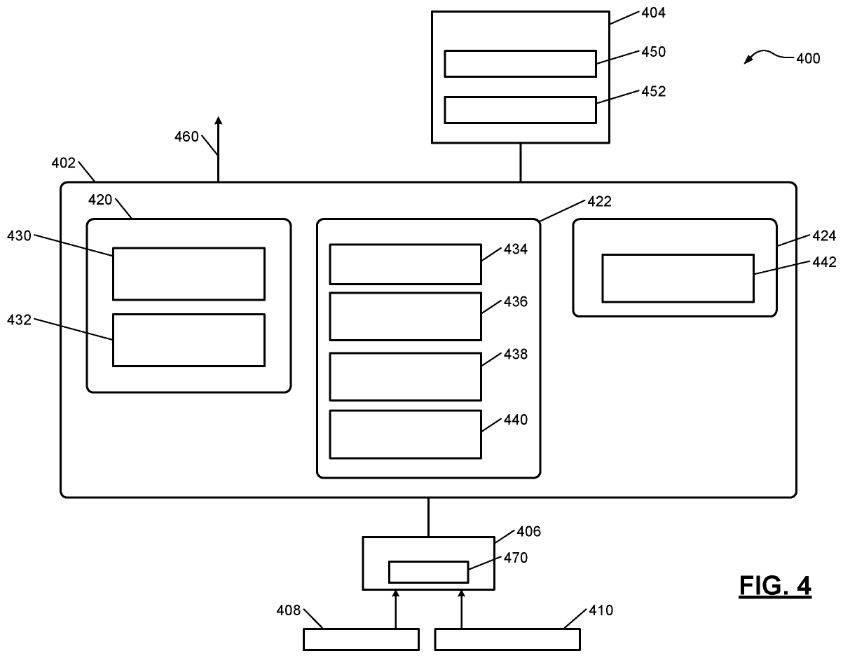

The edge computing devices 104 and the cloud-based network devices 128 may include respective attention-driven strategy modules. The attention-driven strategy modules 130, 132 are shown. Although not shown in FIG. 1, the control modules 122 of the vehicles 102 may also include attention-driven strategy modules, examples of which are shown in FIG. 3. Each of the attention-driven strategy modules perform belief, envision and task relevance operations to provide feedback information to the adaptive streaming modules 126. Attention of a vehicle system may be focused to one or more geographical regions external to the corresponding vehicle. A region may refer to a multi-dimensional space for which an autonomous vehicle perception module implementing a perception algorithm determines to be of interest. As an example, a perception algorithm executed by a perception module (an example of which is shown in FIG. 4) may determine a particular object in a particular region is of interest. One of the attention-driven strategy modules may then as a result request increased resolution for the particular region of interest to, for example, better monitor the object. This may include monitoring a location of the object, a trajectory (or path) of the object, a speed of the object, etc. The attention-driven strategy modules perform the belief, envision and task relevant operations to create streaming strategy profiles. The streaming strategy profiles are sent as feedback information to the adaptive streaming modules 126. The adaptive streaming modules 126 then adjusts streaming parameters based on the feedback information.

The streaming strategy profiles may each include temporal, spatial, and lossy compression information. A temporal domain refers to a sampling frequency of sensor data and adjustment thereof. A sampling frequency may be decreased or increased depending on a level of interest for the corresponding sensor data and/or region of interest. Sensor data may be collected for multiple regions, where each region may have a different level of interest and a different corresponding sampling rate. The sampling rates may be resampling rates. The sampling rates may refer to camera frames per second, global positioning system points per second, a sample rate of an analog signal, etc.

A spatial domain is related to multi-dimensional sensor data and refers to regions of interest including dimensions and locations of the regions. Each region may have an assigned (i) resampling resolution (e.g., a lower or higher image resolution relative to a default resolution), (ii) temporal domain method (may be different for different regions), and (iii) a lossy compression rate (may be different for different regions).

A lossy compression domain refers to lossy compression rates at which sensor data is compressed prior to streaming to a remote device and a lossy compression method. Some example lossy compression methods are (i) the video (or image) compression methods H264 (referred to as an advanced video coding method) and H265 (referred to as a high efficiency video coding method); and (ii) the audio compression methods advanced audio coding (AAC) and moving pictures expert group (MPEG) layer III (MP3). In some embodiments, the stated temporal, spatial and lossy compression methods are combined to filter and compress streaming sensor data sent from the vehicles 102 to the edge computing devices 104 and/or the cloud-based network devices 128.

The edge computing devices 104 may include regional cellular tower devices, base station devices, city level network devices, micro-computing center devices, etc. The edge computing devices 104 do not refer to devices within the vehicles 102. The cloud-based network devices 128 may be part of a distributed network including servers, memory devices with stored databases, etc.

The vehicles 102 may communicate with infrastructure devices 108 via a vehicle-to-infrastructure (V2I) communication links, such as a long-term evolution (LTE) or 5^{th} generation (5G) links. The vehicles 102 may communicate with the edge computing devices 104 via vehicle-to-network (V2N) communication links, such as LTE and 5G links. The vehicles 102 may communicate with the personal mobile network devices 110 via vehicle-to-person (V2P) communication links, such as LTE and 5G links.

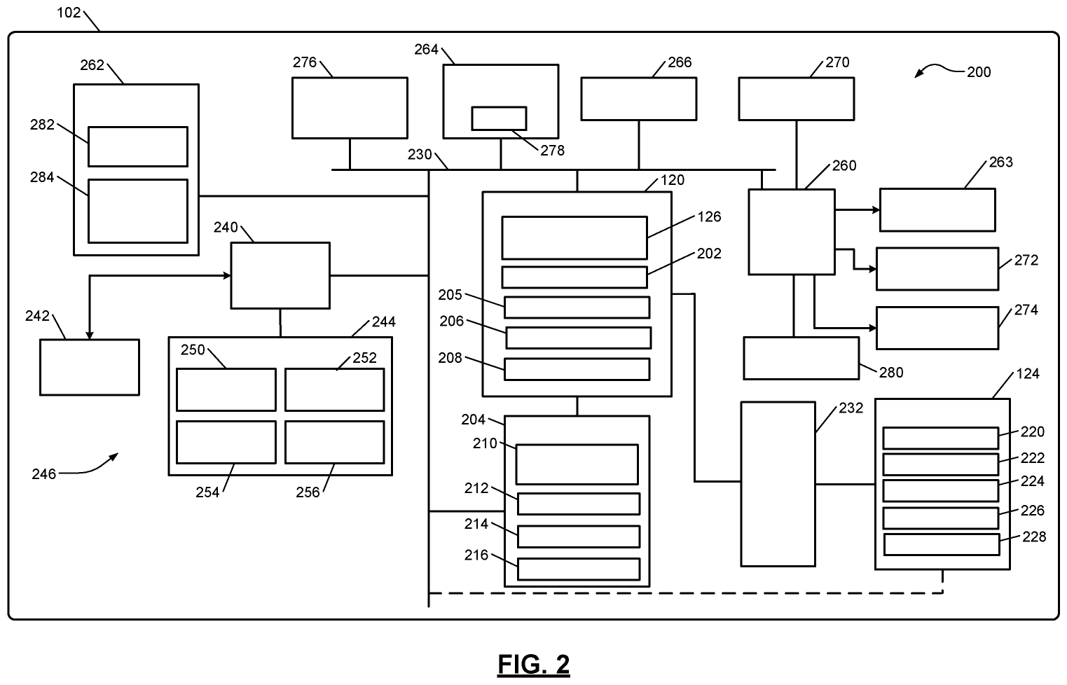

FIG. 2 shows an example of one of the vehicles 102 of FIG. 1. The vehicle 102 includes a vehicle system 200 including the control module 122 and the sensors 124. The vehicle 102 may be a partially or fully autonomous vehicle or other type of vehicle. The control module 122 may include the adaptive streaming module 126, a vehicle-to-infrastructure (V2I) module 202, a perception module 205, a trajectory module 206 and other modules 208. The V2I module 202 may collect data from road infrastructure devices located external to the vehicle. The infrastructure devices may include traffic signals, traffic signs, devices mounted on buildings and/or roadway structures, etc. The control module 122 and/or the adaptive streaming module 126 may implement a neural network and adaptive learning to improve adjustments of the streaming parameters. The perception module 205 may identify upcoming regions of interest and/or events based on currently observed states of the vehicle 102 and the corresponding environment. The perception module 205 may execute perception algorithms to predict what is to occur within the next predetermined period of time. For example, the perception module 205 may predict locations of objects relative to the vehicle 102, a location of the vehicle 102, changes in environmental conditions, changes in road conditions, changes in traffic flow, etc. The trajectory module 206 may determine the trajectories of the vehicle 102 and/or other nearby vehicles. The other modules 208 may include vehicle onboard functions modules, such as that shown in FIG. 3.

The memory 204 may store streaming strategies 210, parameters 212, data 214, and algorithms 216 (e.g., attention-driven strategy algorithms, perception algorithms, etc.). The sensors 124 may be located throughout the vehicle 102 and include cameras 220, infrared (IR) sensors 222, radar sensors 224, lidar sensors 226, and/or other sensors 228. The other sensors 228 may include yaw rate sensors, accelerometers, global positioning system (GPS) sensors, etc. The control module 122 and sensors 124 may be in direct communication with each other, may communicate with each via a controller area network (CAN) bus 230, and/or via an Ethernet switch 232. In the example shown, the sensors 124 are connected to the control module 122 via the Ethernet switch 232, but may also or alternatively be connected directly to the control module 122 and/or the CAN bus 230.

The vehicle 102 may further include a chassis control module 240, torque sources such as one or more electric motors 242 and one or more engines (one engine 244 is shown). The chassis control module 240 may control distribution of output torque to axles of the vehicle 102 via the torque sources. The chassis control module 240 may control operation of a propulsion system 246 that includes the electric motor(s) 242 and the engine(s) 244. The engine 244 may include a starter motor 250, a fuel system 252, an ignition system 254 and a throttle system 256.

The vehicle 102 may further include a body control module (BCM) 260, a telematics module 262, a brake system 263, a navigation system 264, an infotainment system 266, an air-conditioning system 270, other actuators 272, other devices 274, and other vehicle systems and modules 276. The navigation system 264 may include a GPS 278. The other actuators 272 may include steering actuators and/or other actuators. The control module, systems and modules 122, 240, 260, 262, 264, 266, 270, 276 may communicate with each other via the CAN bus 230. A power source 280 may be included and power the BCM 260 and other systems, modules, controllers, memories, devices and/or components. The power source 280 may include one or more batteries and/or other power sources. The control module 122 may and/or the BCM 260 may perform countermeasures and/or autonomous operations based on detected objects, locations of the detected objects, and/or other related parameters. This may include controlling the stated torque sources and actuators as well as providing images, indications, and/or instructions via the infotainment system 266.

The telematics module 262 may include transceivers 282 and a telematics control module 284, which may be used for communicating with other vehicles, networks, edge computing devices, and/or cloud-based devices. The transceivers 282 may include the transceiver 120 of FIG. 1. The BCM 260 may control the modules and systems 262, 263, 264, 266, 270, 276 and other actuators, devices and systems (e.g., the actuators 272 and the devices 274). This control may be based on data from the sensors 124.

FIG. 3 shows a portion 300 of the attention-driven streaming system 100 of FIG. 1. The portion 300 includes a vehicle portion 302 shown on a left side of a dashed line 304 and an edge computing/cloud-based portion 306 shown on a right side of the dashed line 304. The portions 302 and 306, although not shown in FIG. 3, may include respective transceivers. For example, the portion 302 may include the transceivers 282 of FIG. 2. The vehicle portion 302 includes the sensors 124, the adaptive streaming module 126, the memory 204, and vehicle onboard function modules 310. The edge computing/cloud-based portion 306 includes a sensor streaming module 312 and a vehicle monitoring module 314. A communication interface 316 may exist between the portions 302, 306.

The adaptive streaming module 126 may include filters 320, a compression module 322, a streaming strategy module 324, and an attention-driven strategy module 326, which operates similarly as the other attention-driven strategy modules disclosed herein. The filters 320 include temporal filters 330, spatial filters 332, and lossy rate filters 334. The temporal filters 330 sample the sensor data at a set frequency, as described above. The spatial filters 332 select regions of interest, sampling resolution per region monitored, apply temporal domain methods to the corresponding regions monitored, and/or apply different lossy compression rates to the regions monitored. The spatial filters 332 may increase or decrease resolution levels for each region of interest. In one embodiment, the spatial filters 332 transition between three-dimensional (3D) and two-dimensional (2D) collection and filtering of sensor data. The lossy rate filters 334 adjust lossy compression rates of the collected sensor data for the regions monitored and/or select lossy compression methods for the regions monitored. The stated parameters of the filters 330, 332, 334 are set by the streaming strategy module 324. The compression module 322 compresses resultant filtered data output by the filters 320 prior to transmission to the sensor streaming module 312.

The streaming strategy module 324 includes a feedforward channel interface 340, a feedback channel interface 342, a pipeline channel interface 344 and a strategy fusion module 346. The feedforward channel interface 340 receives a first streaming strategy from the attention-driven strategy module 326. The attention-driven strategy module 130 calculates brief and envision data and predicts a need for quality sensor data (sensor data having a higher and/or predetermined minimum resolution level) for one or more regions of interest. For example, the ego-vehicle may make a turn onto a new (or different) road. The attention-driven strategy module 130 may then predict new (or upcoming) vehicles will be observed from a certain direction. The attention-driven strategy module 130 may then calculate the attention area for which to increase resolution. When data from sensors (e.g., lidar sensors and/or cameras) lead to inconsistent perception results, the attention-driven strategy module 130 may increase resolution associated with one or more of the sensors in an attempt to provide consistent results. As an example, the lidar sensors may detect a reflection indicative of presence of an object, whereas computer vision sensors do not detect an object. Thus, a conflict exists between the lidar and computer vision sensors. The attention-driven strategy module 130 may calculate a new sampling rate for one or more sensors to provide higher resolution sensor data in an attempt to correct the inconsistency. If the inconsistency is not corrected, conservative actions may be taken such as reducing ego-vehicle speed, stopping the ego-vehicle, and/or performing other operations.

The attention-driven strategy module 326 operates locally and in a similar manner as the attention-driven strategy module 130. As an example, the attention-driven strategy module 326 may, based on local detection of driving on a highway, direct attention to a region forward of the ego-vehicle and request zooming in and higher resolution for the region. The collected sensor data at the higher resolution for the region may then be sent to the edge computing or cloud-based network device for processing. The attention-driven strategy module 130 may then adjust attention of the adaptive streaming module 126 based on results of the processed data.

As another example, the ego-vehicle may transmit low-resolution data to the edge computing device or cloud-based network device. A vehicle function module at the edge computing device or cloud-based network device determines that there is another vehicle within 100 meters of the ego-vehicle. The vehicle function module provides a confidence level with regards to the detection of the other vehicle and the confidence level is low due to low resolution of the data and size of the image of the other vehicle. The attention-driven strategy module 130 then requests higher resolution data for a region including the other vehicle. The streaming strategy module 324 then adjusts the resolution of the spatial filters 332 to provide higher resolution data back to the edge computing device or cloud-based network device to better monitor the other vehicle and/or determine that the other vehicle (or object) is not of concern.

The feedback channel interface 342 receives a second streaming strategy from the attention-driven strategy module 130. An edge computing device and/or a cloud-based network device may run perception algorithms, create attention-driven strategies, and send feedback to the ego-vehicle and more specifically to the feedforward channel interface 340. The edge computing device and/or cloud-based network device may detect objects and/or events ahead of time and provide feedback to allow for preparation for an event and/or to adjust resolutions of data collected for one or more regions. This may include a decrease in resolution, an increase in resolution, and/or a combination of both for one or more regions.

As an example, the edge computing device and/or cloud-based network device may detect a small object at a distance of 100 meters from the ego-vehicle and determine that a detection confidence level for this object is low. The edge computing device and/or cloud-based network device may send feedback information to the ego-vehicle to request higher resolution data. As another example, the edge computing device and/or cloud-based network device may crowd-source environment data from multiple vehicles and detect a road at least partially covered by snow. The edge computing device and/or cloud-based network device may then send feedback information to the ego-vehicle to request higher resolution data before the ego-vehicle enters an area with snow.

As another example, the edge computing device and/or cloud-based network device may crowd-source road traffic data from multiple vehicles and detect a certain traffic shockwave at a highway curvature (vision occlusion for ego-vehicle). The edge computing device and/or cloud-based network device may then send feedback information to the vehicle to request higher resolution data before the ego-vehicle enters the curvature in the highway.

The pipeline channel interface 344 receives a congestion signal from the communication interface 316. The congestion signal may indicate: congestion at the sensor streaming module 312; another streaming strategy; and/or streaming parameters. The congestion may be due to (i) the amount of received data being more than the amount forwarded from the sensor streaming module 312 to the vehicle monitoring module 314, and/or (ii) the transmission rate at which the data is received being higher than the transmission rate at which the data is forwarded from the sensor streaming module 312 to the vehicle monitoring module 314. Congestion at the vehicle monitoring module 314 may cause congestion at the sensor streaming module 312.

The strategy fusion module 346 determines a collective (or adaptive) streaming strategy based on the first and second streaming strategies and the congestion signal. As a result, the strategy fusion module 346 leverages three resources to drive attention of the filters 320 to certain regions of interest. Congestion may occur, for example, when the ego-vehicle moves to a LTE coverage area where signals are weak and/or a communication link between the ego-vehicle and the edge computing or cloud-based network device is slow. On the edge computing or cloud-based network device side, congestion may also or alternatively occur when processing throughput of vehicle functions slows down.

The strategy fusion module 346 may arbitrate the streaming strategies and parameters received from the channel interfaces 340, 342, 344. In one embodiment, the strategy fusion module 346 operates based on a hierarchy. The strategy fusion module 346 may prioritize which streaming strategy and/or parameters to use for certain situations. When a streaming strategy provided by the edge computing or cloud-based network device conflicts with the streaming strategy locally determined by the attention-driven strategy module 326, the strategy fusion module 346 may select the most conservative strategy or combine the two or more strategies to provide a resultant strategy to use at the filters 320. The strategy fusion module 346 may select a strategy that reduces and/or eliminates congestion at the edge computing device and/or cloud-based network device.

The pipeline associated with the transfer of signals between the ego-vehicle and the edge computing device and/or cloud-based network device includes serial components (or elements). Some examples of the components (or elements) are 4^{th} generation (4G) and/or fifth generation (5G) channels, video encoding and decoding devices, and applications stored on the edge computing device and/or cloud-based network device). The pipeline channel interface 344 monitors congestion levels at the stated components (or elements) and elsewhere and adjusts the sensor streaming rate of compressed sensor data sent to the sensor streaming module 312 of FIG. 3. The sensor streaming rate is adjusted to avoid congestion and accumulated end-to-end latencies.

The memory 204 stores states 348 of (i) the ego-vehicle associated with the sensors 124 and modules 126, 310, and (ii) the environment of the ego-vehicle (referred to as the “world” state). This state information is provided to the attention-driven strategy module 326.

The vehicle onboard function modules 310 may include a V2I module 202, a perception module 205, a trajectory module 206, an actuator control module 350 and/or other vehicle function modules. The vehicle onboard function modules 310 may include any vehicle function modules that invoke sensor data processing. The vehicle onboard function modules 310 may perform operations based on a state signal 352 indicating a state of the ego-vehicle and the world state as determined by the vehicle monitoring module 314. The actuator control module 350 may control the brake system 263 and/or the other actuators 272 of FIG. 2. The actuator control module 350 may, for example, control motors, steering, braking, accelerating, and decelerating of the vehicle based on results of analyzing the monitored data from the sensors, the states of the ego-vehicle, the world state, and/or other collected information and/or data. The control module 122 of FIG. 2 may control other driver assistance operations based on the results of analyzing the monitored data from the sensors, the states of the ego-vehicle, the world state, and/or other collected information and/or data, such as displaying warning indicators and/or suggested operational instructions.

The sensor streaming module 312 and the vehicle monitoring module 314 of FIG. 3 may be implemented at any one of the edge computing devices 104 and/or cloud-based network devices 128 of FIG. 1. The sensor streaming module 312 may include a decompression module 360 and a pipeline monitoring module 362. The decompression module 360 decompresses compressed data received from the compression module 322. The pipeline monitoring module 362 monitors whether there is congestion at the sensor streaming module 312 and indicates whether congestion exists to another pipeline monitoring module 364 of the vehicle monitoring module 314. The pipeline monitoring module 364 determines whether congestion exists at the vehicle monitoring module 314 and indicates whether congestion exists at the sensor streaming module 312 and/or at the vehicle monitoring module 314 to another pipeline monitoring module 370 and/or directly to the pipeline channel interface 344. The pipeline monitoring module 370 may be part of the communication interface 316 and be a station, a node, or other network device located between the pipeline monitoring module 364 and the pipeline channel interface 344. The pipeline monitoring module 370 may forward the congestion information received from the pipeline monitoring module 364 to the pipeline channel interface 344.

The vehicle monitoring module 314 may further include vehicle function modules 372 and memory 374. The vehicle function modules 372 may include a perception module 376, an object detection module 378, a tracking module 380, a positioning and mapping module 382, a trajectory planning module 384, a vehicle-to-network (V2N) module 386 and/or other vehicle function modules. The vehicle function modules 372 may include any vehicle function modules that invoke sensor data processing. The perception module 376 may identify upcoming regions of interest and/or events based on currently observed states of the ego-vehicle and the corresponding environment similar to the perception module 205 of FIG. 2. The object detection module 378 detects objects within a set distance of the ego-vehicle. The tracking module 380 may track the environment conditions and/or locations of the detected objects relative to the ego-vehicle. The positioning and mapping module 382 may map locations of the ego-vehicle and the objects relative to a geographical map of an area in which the ego-vehicle is located. The trajectory planning module 384 may monitor, update and predict trajectories of the ego-vehicle and the objects. The V2N module 386 may collect data from other devices nearby and/or approaching the ego-vehicle. The collected data may include status information of the objects and/or other devices.

The memory 374 stores states 388 of the ego-vehicle, the objects, and the environment (also referred to as a “world” state) as determined by the vehicle function modules 372. The states 388 are provided to the attention-driven strategy module 130, which generates the second streaming strategy based on the states 388.

In FIG. 3, the dashed lines between modules may refer to control flow signals. The solid lines between modules may refer to data flow signals.

As an example, the adaptive streaming module 126 of FIG. 3 may receive camera frames from one or more cameras. The compression module 322 may compress filtered data received from the adaptive streaming module 126 and send the data to the sensor streaming module 312. The decompression module 360 may decode the data. The object detection module 378 may then detect objects within a predetermined distance of the ego-vehicle of the adaptive streaming module 126 and generate corresponding confidence levels associated with the detected objects and provide this information as feedback information to the adaptive streaming module 126. The adaptive streaming module 126 may then adjust resolution for focused regions of the detected objects. Resolution of other regions monitored may be reduced. This allows bandwidth needed for transmitting sensor data to not be increased while increasing resolution for selected regions of interest. Confidence levels for the detected objects may remain the same or increase due to the increased resolution for the regions in which the objects are located.

FIG. 4 shows a portion 400 of the attention-driven streaming system of FIG. 3. The portion 400 includes an example of an attention-driven strategy module 402, a first memory 404, a second memory 406, a V2I module 408, and a perception module 410. The attention-driven strategy module 402 may operate similarly as and/or replace any of the attention-driven strategy modules disclosed herein. The attention-driven strategy module 402 may include a belief module 420, an envision module 422 and a task relevance module 424. The belief module 20 may include a state confidence module 430 and a sensor disparity module 432. The envision module 422 includes the map tracking module 434, the environment tracking module 436, a situation awareness module 438, and a trajectory planning module 440. The task relevance module 424 includes a scene analysis module 442.

The attention-driven strategy module 402 based on outputs of the modules 420, 422 and 424 generates a streaming strategy signal 460, which may include a streaming strategy profile (or simply “streaming strategy”). The streaming strategy signal 460 may be provided as (i) feedforward information if the attention-driven strategy module 402 is implemented as part of a vehicle, or (ii) feedback information if the attention-driven strategy module 402 is implemented as part of an edge computing device or cloud-based network device.

The first memory 404 may include a map database 450 and an external database 452. The map database 450 may include road topology information, intersection information, traffic rules, etc. The external database 452 may include weather information (e.g., whether it is snowing, raining, foggy, sunny, cloudy, etc.), road surface conditions, traffic congestion information, etc. The second memory 406 stores states 470 of the ego-vehicle and environment of the ego-vehicle (or “world” state). The V2I module 408 and the perception module 410 may indicate states of the ego-vehicle and/or the environment.

The modules 420, 422, 424 may operate based on the information stored in the memories 404, 406. The belief module 420 may determine a probabilistic representation of an object state (x, y, z, speed, heading, etc.). This includes indicating whether the objects have already been detected and/or the events have already been observed. The state confidence module 430 may determine confidence levels of the detected and/or predicted objects and events. Variance and co-variance values of the observed states and/or predicted states may be calculated. The sensor disparity module 432 may determine differences and/or conflicts between data collected from different sensors. For example, when a first sensor indicates a different state of an object than a second sensor.

The envision module 422 lists objects and events that are expected to exist and/or to occur in in a multi-dimensional space. The events may be events expected to happen and/or be observed in the near future. The map tracking module 434 tracks the ego-vehicle's location on a map. For example, if the ego-vehicle is at an intersection, attention is given to headings of the coming-vehicles. The environment tracking module 436 tracks the environment conditions from external databases, such as weather, light conditions, traffic congestion, etc. For example, if it is dark (e.g., nighttime) and/or it is snowy or rainy, a base attention level may be increased to transmit more data within a predetermined period of time.

The situation awareness module 438 may receive vehicle situation awareness information from neighboring vehicles via vehicle-to-vehicle (V2V), V2I and V2N communications. For example, based on situation awareness information, the ego-vehicle may predict the attention region. The trajectory planning module 440 plans the short range trajectory of the ego-vehicle for a control module of the ego-vehicle.

The scene analysis module 442 of the task relevance module 424 performs task driven scene analysis including analyzing a scene and identifying attention regions, which are relevant to the current tasks. The scene analysis module 442 may, for example, determine when the ego-vehicle is approaching an intersection that one region of interest includes traffic lights of the intersection. Another region of interest may include an area where vehicles are approaching the intersection from a direction perpendicular to a traveling direction of the ego-vehicle. As another example, the scene analysis module 442 may detect when the ego-vehicle is changing lanes. One or more regions including at least portions of the neighboring lanes, as opposed to a current lane of the ego-vehicle, then become the regions of interest (or attention).

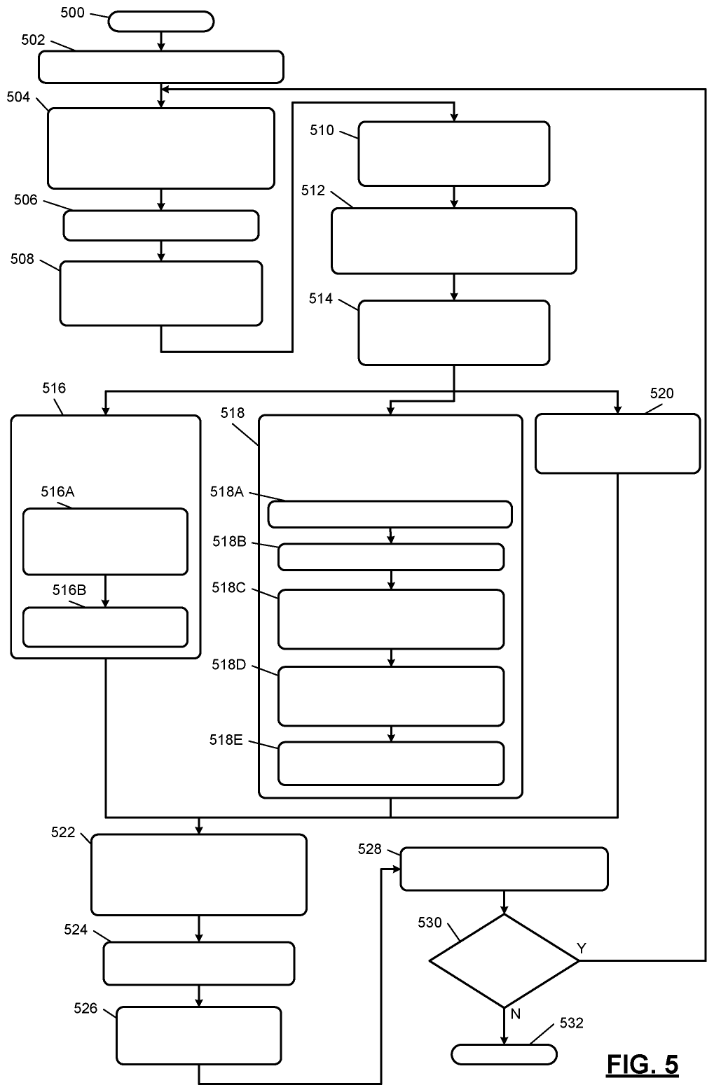

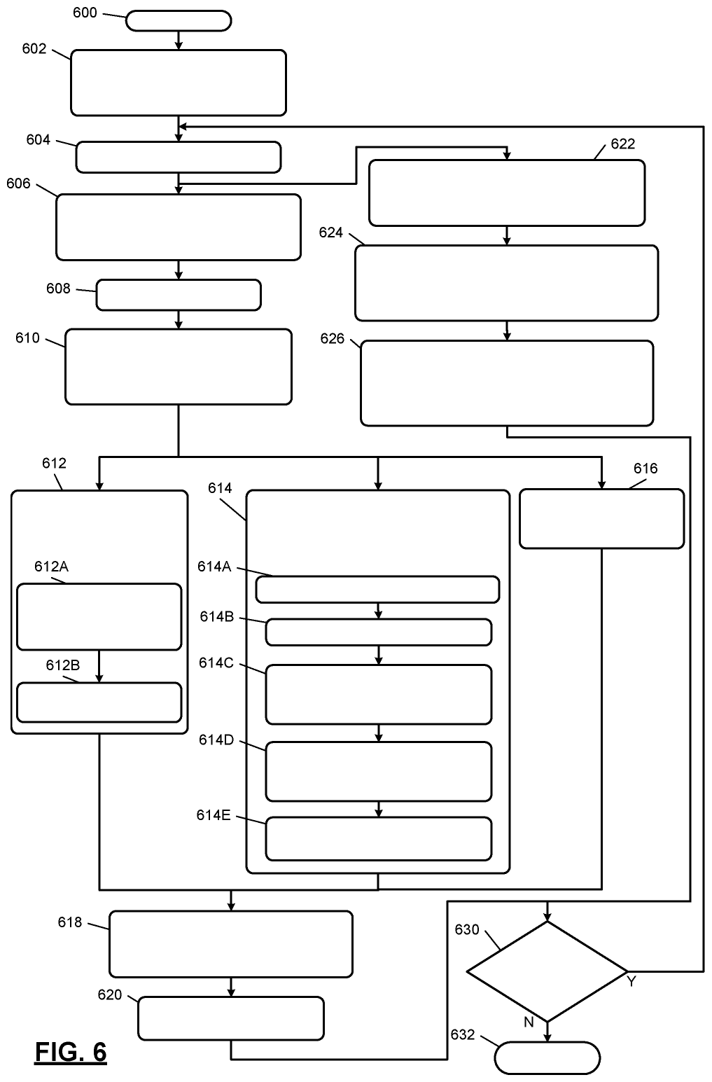

FIG. 5 shows a first portion of adaptive streaming method implemented by a vehicle (e.g., one of the vehicles 102 of FIGS. 1 and 2). Although the following operations of FIGS. 5-6 are primarily described with respect to the examples of FIGS. 1-4, the operations are applicable to other embodiments of the present disclosure. The operations of the method may be iterative performed. The method may begin at 500. At 502, the sensors 124 may generate sensor data. At 504, the filters 320 may filter the sensor data according to default or a latest multi-channel based filtering strategy to provide filtered data. At 506, the compression module 322 compresses the filtered data.

At 508, the transceivers 282 of FIG. 2 transmits the compressed data to an edge computing device or a cloud-based network device including the decompression module 360 of FIG. 3.

At 510, the feedback channel interface 342 receives, in response to transmitting the compressed data, remote determined stated of the ego-vehicle and the environment (or world state) is received via the signal 352 generated by the memory 374. The state information may include locations and trajectories of the ego-vehicle and nearby objects, as well as road and weather conditions. This information may be received from the attention-driven strategy module

At 512, the vehicle onboard function modules 310 execute vehicle functions to provide state of vehicle and state of environment of the ego-vehicle to the memory 204. These functions are performed based on the state information received from the memory 374 at 510. At 514, the memory 204 stores and provides the states of the ego-vehicle and the environment to the attention-driven strategy module 326.

The following operations 516, 518 and 520 may be concurrently performed. At 516, the attention-driven strategy module 326 performs belief, envision and task relevance operations based on the received states of the ego-vehicle and the environment. At 516A, a first belief module determines a probabilistic representation of states of one or more objects. At 516B, the first belief module determines confidence levels of the one or more observed states.

At 518, the first belief module determines disparities between sensors indicating different states of the same one or more objects, different road conditions for the same road, and/or different weather conditions for the same weather. The first envision module generates a list of objects and/or events for a multi-dimensional space that are expected to be detected and/or observed in the future. At 518A, the first envision module tracks vehicle locations on a map. At 518B, the first envision module tracks environmental conditions. At 518C, the first envision module collects status information from other vehicles to provide situation awareness information. The situation awareness information may include object information, road conditions and weather conditions. The situation awareness information may also include distances between the objects and the ego-vehicle, rates of change in the distances, indications of whether the distances are increasing or decreasing, etc. At 518D, the first envision module predicts an attention region to monitor based on the situation awareness information. At 518E, the first envision module plans a short range trajectory of the ego-vehicle.

At 520, a first task relevance module analyzes current scene of the one or more monitored regions and identifies one or more attention regions. The attention regions may be portions of the currently monitored one or more regions or other regions.

At 522, the first attention-driven strategy module determines a local attention-driven strategy at the ego-vehicle based on the confidence levels, the sensor disparities, the situation awareness information, the short range trajectory of the ego-vehicle and the one or more attention regions. The local attention-driven strategy includes temporal, spatial and/or lossy rate values for the filters 320.

At 524, the pipeline channel interface 344 may receive a streaming strategy adjustment value and/or other temporal, spatial and/or lossy rate values for the filters 320. The streaming strategy adjustment value may be provided to alleviate congestion occurring at one of the modules 312, 314.

At 526, the first attention-driven strategy module may receive a remote attention-driven strategy from the edge computing device or the cloud-based network device as feedback information at the feedback channel interface. The remote attention-driven strategy is determined at the edge computing device or cloud-based network device remotely away from the vehicle based on the data streamed from the vehicle to the edge computing device or cloud-based network device.

At 528, the strategy fusion module 346 determines a multi-channel based filtering strategy, which is provided to the filters 320. This includes temporal, spatial and lossy rate filter parameters to adaptively adjust the streaming of data to the edge computing device or cloud-based network device.

At 530, the adaptive streaming module 126 may determine if there is additional sensor data to filter. If yes, operation 504 may be performed, otherwise the method may end at 532.

FIG. 6 shows a second portion of the adaptive streaming method implemented by an edge computing or cloud-based network device (one of the devices 104, 128 of FIG. 1. The second portion may begin at 600. At 602, the decompression module 360 receives the compressed data from the compression module 322. At 604, the decompression module 360 decompresses the compressed data and forwards the decompressed sensor data to the vehicle monitoring module 314.

At 606, the vehicle function modules 372 executes vehicle functions to provide a state of the ego-vehicle and a state of the environment of the ego-vehicle. At 608, the states are stored in the memory 374. At 610, the memory 374 and/or the vehicle monitoring module 314 provides the states, as described above, to the vehicle onboard function modules 310.

The following operations 612, 614, 616 may be concurrently performed. At 612, the attention-driven strategy module 130 performs belief, envision and task relevance operations based on the states of the ego-vehicle and the environment. At 612A, a second belief module determines a probabilistic representation of states of one or more objects. At 612B, the second belief module determines confidence levels of the one or more observed states.

At 614, the second belief module determines disparities between sensors indicating different states of the same one or more objects, different road conditions for the same road, and/or different weather conditions for the same weather. The second envision module generates a list of objects and/or events for a multi-dimensional space that are expected to be detected and/or observed in the future. At 614A, the second envision module tracks vehicle locations on a map. At 614B, the second envision module tracks environmental conditions. At 614C, the second envision module collects status information from other vehicles to provide situation awareness information. The situation awareness information may include object information, road conditions and weather conditions. The situation awareness information may also include distances between the objects and the ego-vehicle, rates of change in the distances, indications of whether the distances are increasing or decreasing, etc. At 614D, the second envision module predicts an attention region to monitor based on the situation awareness information. At 614E, the second envision module plans a short range trajectory of the ego-vehicle.

At 616, a second task relevance module analyzes current scene of the one or more monitored regions and identifies one or more attention regions. The attention regions may be portions of the currently monitored one or more regions or other regions.

At 618, the attention-driven strategy module 130 determines the remote attention-driven strategy based on the confidence levels, the sensor disparities, the situation awareness information, the short range trajectory of the ego-vehicle and the one or more attention regions determined at 614, 616, 618. The local attention-driven strategy includes temporal, spatial and/or lossy rate values for the filters 320.

At 620, the attention-driven strategy module 130 may transmit the remote attention-driven strategy to the feedback channel interface 342 of the ego-vehicle.

At 622, the pipeline monitoring module 362 monitors congestion levels at the sensor streaming module 312 and generates a first streaming rate adjustment value. At 624, the pipeline monitoring module 364 monitors congestion levels at the vehicle monitoring module 314 and/or vehicle function modules 372 and generates a second streaming rate adjustment value, which may be based on the first streaming rate adjustment value. At 626, the pipeline monitoring module 364 may transmit the second streaming rate adjustment value to the pipeline channel interface 344 via the communication interface 316 and/or pipeline monitoring module 370.

At 630, the sensor streaming module 312 may determine if additional streaming data has been received. If yes, operation 604 may be performed, otherwise the method may end at 632.

An architecture is disclosed herein that uses attention-driven strategies to prioritize sensor data based on scene understanding and task-driven strategies while streaming the sensor data for edge computing and cloud-based network devices in real time. The adaptive streaming module 126 of FIG. 3 may determine a loss function generated based on (i) a quality-of-service (QoS) determination for streamed data from onboard sensors to offboard network devices, and (ii) perception performance. The adaptive streaming module 126 may adjust operations of the filters 320 as described above based on the loss function. Sets of strategies may be generated and implemented based on perception attention operations to adjust sensor streaming data rates. The trade-off between bandwidth usage and edge computing/cloud side function performance is balanced without sacrificing perception performance (e.g., an object detection rate). This improves cloud-based processing of sensor data for mission critical real-time applications and overcomes the disadvantages associated with traditional cloud-based processing. Processing capabilities of edge computing and cloud-based network devices are leveraged in real-time to enhance local vehicle operations.

The examples include selective attention as an input for real-time adaptive sensor data streaming strategies. Three independent sources are used to derive attention strategies. The sources include belief, envision and task relevance sources. In one embodiment, a task-oriented strategy is used and certain regions are selected for high quality images while data from other regions and/or sensors are partially neglected and/or ignored. The partial neglecting of the other regions may include collecting images with reduced image quality for the other regions and/or using less resources (processing power, processing time, memory, etc.) to process data for the other regions.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java@, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. An attention-driven streaming system comprising:
an adaptive-streaming module comprising
a plurality of filters configured to filter sensor data received from a plurality of sensors of a vehicle,
a compression module configured to compress the filtered sensor data to generate compressed data,
an attention-driven strategy module configured to generate feedforward information based on a state of the vehicle and a state of an environment of the vehicle to adjust a region of interest, and
a fusion module configured to generate an adaptive streaming strategy to adaptively adjust operations of each of the plurality of filters; and
a transceiver configured to stream the compressed data to at least one of an edge computing device or a cloud-based network device and in response receive feedback information and pipeline monitoring information,
wherein the fusion module is configured to generate the adaptive streaming strategy based on the feedforward information, the feedback information and the pipeline monitoring information.

2. The attention-driven streaming system of claim 1, wherein the plurality of filters comprise:
a temporal domain filter configured to resample the sensor data at a set frequency;
a spatial domain filter configured to select one or more geographical regions external to the vehicle; and
a lossy compression filter configured to at least one of select a lossy compression method or a lossy compression rate of the compression module.

3. The attention-driven streaming system of claim 2, wherein the spatial domain filter is configured to:
select one or more image resolutions respectively for the selected one or more geographical regions;
apply one or more temporal domain methods respectively to the selected one or more geographical regions; and
adjust one or more different lossy compression rates for the one or more regions.

4. The attention-driven streaming system of claim 1, wherein:
the feedforward information is a first streaming strategy for streaming data to the at least one of the edge computing device or the cloud-based network device; and
the feedback information is a second streaming strategy for streaming data to the at least one of the edge computing device or the cloud-based network device.

5. The attention-driven streaming system of claim 1, wherein the feedforward information is generated within the vehicle and includes a request for higher resolution data for the region of interest.

6. The attention-driven streaming system of claim 1, wherein:
the feedforward information includes a streaming strategy generated based on prediction information generated within the vehicle and indicates a geographical region to focus monitoring; and
the plurality of filters are configured to adjust a sampling rate of one or more of the plurality of sensors for the geographical region based on the streaming strategy in the feedforward information.

7. The attention-driven streaming system of claim 1, wherein the feedback information is generated within the at least one of the edge computing device or the cloud-based network device and includes a request for higher resolution data for an indicated geographical region.

8. The attention-driven streaming system of claim 1, wherein:
the feedback information includes a streaming strategy generated based on prediction information generated within the at least one of the edge computing device or the cloud-based network device and indicates a geographical region to focus monitoring; and
the plurality of filters are configured to adjust a sampling rate of one or more of the plurality of sensors for the geographical region based on the streaming strategy included in the feedback information.

9. The attention-driven streaming system of claim 1, wherein the pipeline monitoring information indicates an adjustment in a streaming rate of the compressed data based on congestion at the at least one of the edge computing device or the cloud-based network device.

10. The attention-driven streaming system of claim 1, wherein the attention-driven strategy module is configured to generate the feedforward information based on:
a probabilistic representation of a state of an object;
a confidence level of the state of the object; and
a list of objects expected to be observed in the future and events expected to occur in the future.

11. The attention-driven streaming system of claim 1, wherein the attention-driven strategy module is configured to generate the feedforward information based on at least one of:
differences between different sensors;
current and upcoming environmental conditions currently experienced or to be experienced by the vehicle;
status information from a neighboring vehicle; or
map tracking and trajectory planning information.

12. The attention-driven streaming system of claim 1, wherein the attention-driven strategy module is configured to generate the feedforward information to include one or more attention regions for tasks being performed.

13. A vehicle system comprising:
the attention-driven streaming system of claim 1; and
the plurality of sensors.

14. An attention-driven strategy method comprising:
filtering via a plurality of filters sensor data received from a plurality of sensors at a vehicle;
compressing the filtered sensor data to generate compressed data;
generating feedforward information based on a state of the vehicle and a state of an environment of the vehicle;
generating an adaptive streaming strategy to adaptively adjust operations of each of the plurality of filters; and
streaming the compressed data from the vehicle to at least one of an edge computing device or a cloud-based network device and in response receiving feedback information and pipeline monitoring information from the edge computing device or the cloud-based network device,
wherein the adaptive streaming strategy is generated based on the feedforward information, the feedback information and the pipeline monitoring information.

15. The attention-driven strategy method of claim 14, wherein the filtering of the sensor data comprises:
resampling the sensor data at a set frequency;
selecting one or more geographical regions external to the vehicle; and
at least one of selecting a lossy compression method or a lossy compression rate for compressing the sensor data.

16. The attention-driven strategy method of claim 14, wherein:
the feedforward information is a first streaming strategy for streaming data to the at least one of the edge computing device or the cloud-based network device; and
the feedback information is a second streaming strategy for streaming data to the at least one of the edge computing device or the cloud-based network device.

17. The attention-driven strategy method of claim 14, wherein at least one of the feedforward information or the feedback information includes a request for higher resolution data for an indicated geographical region.

18. The attention-driven strategy method of claim 14, wherein:
the feedforward information includes a streaming strategy generated based on prediction information generated within the vehicle and indicates a geographical region to focus monitoring; and
the filtering includes adjusting a sampling rate of one or more of the plurality of sensors for the geographical region based on the streaming strategy in the feedforward information.

19. The attention-driven strategy method of claim 14, wherein:
the feedback information includes a streaming strategy generated based on prediction information generated within the vehicle and indicates a geographical region to focus monitoring; and
the filtering includes adjusting a sampling rate of one or more of the plurality of sensors for the geographical region based on the streaming strategy in the feedback information.

20. The attention-driven strategy method of claim 14, wherein the adaptive streaming strategy includes increasing resolution for a first region of interest and decreasing resolution for a second region of interest.
